(19) United States
(12) Patent Application Publication
(10) Pub. No.: US 2019/0132251 A1
(43) Pub. Date: May 2, 2019

(54) METHOD AND SYSTEM FOR SUPPORTING MULTIPLE QOS FLOWS FOR UNSTRUCTURED PDU SESSIONS

(71) Applicants: Ngoc Dung DAO, Ottawa (CA); Xu LI, Nepean (CA)

(72) Inventors: Ngoc Dung DAO, Ottawa (CA); Xu LI, Nepean (CA)

(73) Assignee: Huawei Technologies Co., Ltd., Shenzhen (CN)

(21) Appl. No.: 16/172,217

(22) Filed: Oct. 26, 2018

Related U.S. Application Data
(60) Provisional application No. 62/579,610, filed on Oct. 31, 2017.

(51) Int. Cl. H04L 12/851; H04L 29/06; H04L 29/12

(52) U.S. Cl. CPC H04L 47/2441; H04L 61/2007; H04L 69/22

(57) ABSTRACT

A method of transmitting PDU packets of an unstructured PD session comprises: mapping UpLink packet and QFI of unstructured PDU session, reading a QoS flow identifier (QFI) of a received UpLink PDU packet of the unstructured PD session; identifying IP header information associated with the QFI; encapsulating the UpLink PDU packet with the identified IP header information; and transmitting the encapsulated UpLink PDU packet.

### REFERENCE TO RELATED APPLICATIONS

The present application claims priority from U.S. Provisional Patent Application No. 62/579,610, filed on 31 Oct. 2017 with title Support Multiple QoS Flows for Unstructured PDU Sessions and incorporated herein by reference in its entirety.

### FIELD OF THE INVENTION

The present invention pertains to the field of communications networks, and in particular to Supporting Multiple Flows within Unstructured PDU (Protocol Data Unit) Sessions, each of the flows having its own Quality of Service (QoS) which may not be related to that of other flows, in which network functions of communications networks may not know or partially know the structure of data packets.

### BACKGROUND

The networks complying with the Third Generation Partnership Project (3GPP) 5G standards (e.g. Release 15 and beyond) are expected to provide extensive support for IPv4, IPv6 and Ethernet packet flows within at least one of the core network and the radio access network. A wide variety of other PDU formats can be supported by such networks by making use of a so-called “unstructured” PDU session, in which traffic forwarding is handled with little or no reference to the content of the packet header. A limitation of this approach is that a given unstructured PDU session can support only one QoS flow, since only one QoS level can be applied to the traffic within that unstructured PDU session. If the unstructured PDU session is used to support a plurality of different sessions (each using the same or a different PDU format), each of these different sessions will be treated with the same QoS.

It would be desirable to support more than one QoS flow within a single unstructured PDU Session.

This background information is intended to provide information that may be of possible relevance to the present invention. No admission is necessarily intended, nor should be construed, that any of the preceding information constitutes prior art against the present invention.

### SUMMARY

An object of embodiments of the present invention is to provide techniques for supporting multiple QoS flows in an Unstructured PDU Session.

An aspect of the present invention provides a method of transmitting PDU packets of an unstructured PDU session. The method comprises: reading a QoS flow identifier (QFI) of a received UpLink (UL) PDU packet of the unstructured PD session; identifying header information associated with the QFI; encapsulating the UpLink PDU packet with the identified header information; and transmitting the encapsulated UpLink PDU packet.

A further aspect of the present invention provides a method of transmitting PDU packets of an unstructured PDU session. The method comprises: reading header information of a received DownLink (DL) PDU packet of the unstructured PDU session; identifying a QoS policy associated with the header information; and transmitting the DownLink PDU packet using the identified QoS policy.

### BRIEF DESCRIPTION OF THE FIGURES

Further features and advantages of the present invention will become apparent from the following detailed description, taken in combination with the appended drawings, in which:

FIG. 1 is a block diagram of an electronic device within a computing and communications environment that may be used for implementing devices and methods in accordance with representative embodiments of the present invention;

FIG. 2 is a block diagram illustrating a logical platform under which an Electronic Device can provide virtualization services;

FIG. 3A is a block diagram illustrating a service-based view of a system architecture of a 5G Core Network; FIG. 3B illustrates another service-based view of a system architecture of a 5G Core Network;

FIG. 4 is a block diagram illustrating a Protocol Data Unit (PDU) of User Plane (UP) traffic flows in the 5G Core Network (CN);

FIG. 5 is a call flow diagram illustrating a representative UpLink (UL) PDU transmission process;

FIG. 6 is a call flow diagram illustrating a representative process for adding a QoS flow to an existing unstructured PDU session;

FIG. 7 is a call flow diagram illustrating a representative process for removing QoS profile information;

FIG. 8 illustrates an example of an Electronic Device (for example a UE) which utilizes packet filters for structured PDU sessions;

FIGS. 9A and 9B illustrate embodiments in which packet classification into QoS flows is performed using application software; FIG. 9A illustrates a first embodiment; while FIG. 9B illustrates an alternative, which does not require changes to the application software.

It will be noted that throughout the appended drawings, like features are identified by like reference numerals.

### DETAILED DESCRIPTION

In the following description, features of the present invention are described by way of example embodiments. For convenience of description, these embodiments make use of features and terminology known from communication system specifications, such as 4G and 5G networks, as defined by the Third Generation Partnership Project (3GPP). However, it shall be understood that the present invention is not limited to such networks.

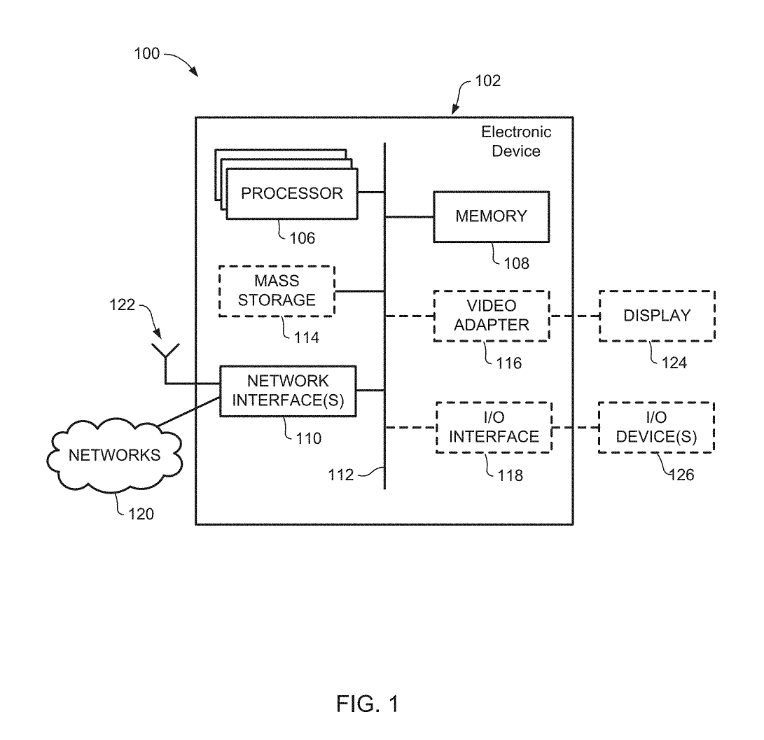

FIG. 1 is a block diagram of an electronic device (ED) 102 illustrated within a computing and communications environment 100 that may be used for implementing the devices and methods disclosed herein. In some embodiments, the electronic device 102 may be an element of communications network infrastructure, such as a base station (for example a NodeB, an enhanced Node B (eNodeB), a next generation Node B (sometimes referred to as a gNodeB or gNB)), a home subscriber server (HSS), a gateway (GW) such as a packet gateway (PGW) or a serving gateway (SGW) or various other nodes or functions within an evolved packet core (EPC) network. In other embodiments, the electronic device 102 may be a device that connects to network infrastructure over a radio interface, such as a mobile phone, smart phone or other such device that may be classified as a User Equipment (UE). In some embodiments, ED 102 may be a Machine Type Communications (MTC) device (also referred to as a machine-to-machine (m2m) device), or another such device that may be categorized as a UE despite not providing a direct service to a user. In some references, an ED 102 may also be referred to as a mobile device (MD), a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The electronic device 102 typically includes a processor 106, such as a Central Processing Unit (CPU), and may further include specialized processors such as a Graphics Processing Unit (GPU) or other such processor, a memory 108, a network interface 110 and a bus 112 to connect the components of ED 102. ED 102 may optionally also include components such as a mass storage device 114, a video adapter 116, and an I/O interface 118 (shown in dashed lines).

The memory 108 may comprise any type of non-transitory system memory, readable by the processor 106, such as static random-access memory (SRAM), dynamic random access memory (DRAM), synchronous DRAM (SDRAM), read-only memory (ROM), or a combination thereof. In specific embodiments, the memory 108 may include more than one type of memory, such as ROM for use at boot-up, and DRAM for program and data storage for use while executing programs. The bus 112 may be one or more of any type of several bus architectures including a memory bus or memory controller, a peripheral bus, or a video bus.

The electronic device 102 may also include one or more network interfaces 110, which may include at least one of a wired network interface and a wireless network interface. As illustrated in FIG. 1, network interface 110 may include a wired network interface to connect to a network 120, and also may include a radio access network interface 122 for connecting to other devices over a radio link. When ED 102 is network infrastructure, the radio access network interface 122 may be omitted for nodes or functions acting as elements of the Core Network (CN) other than those at the radio edge (e.g. an eNB). When ED 102 is infrastructure at the radio edge of a network, both wired and wireless network interfaces may be included. When ED 102 is a wirelessly connected device, such as a User Equipment, radio access network interface 122 may be present and it may be supplemented by other wireless interfaces such as WiFi network interfaces. The network interfaces 110 allow the electronic device 102 to communicate with remote entities such as those connected to network 120.

The mass storage 114 may comprise any type of non-transitory storage device configured to store data, programs, and other information and to make the data, programs, and other information accessible via the bus 112. The mass storage 114 may comprise, for example, one or more of a solid-state drive, hard disk drive, a magnetic disk drive, or an optical disk drive. In some embodiments, mass storage 114 may be remote to the electronic device 102 and accessible through use of a network interface such as interface 110. In the illustrated embodiment, mass storage 114 is distinct from memory 108 where it is included, and may generally perform storage tasks compatible with higher latency, but may generally provide lesser or no volatility. In some embodiments, mass storage 114 may be integrated with a memory 108 to form an heterogeneous memory.

The optional video adapter 116 and the I/O interface 118 (shown in dashed lines) provide interfaces to couple the electronic device 102 to external input and output devices. Examples of input and output devices include a display 124 coupled to the video adapter 116 and an I/O device 126 such as a touch-screen coupled to the I/O interface 118. Other devices may be coupled to the electronic device 102, and additional or fewer interfaces may be utilized. For example, a serial interface such as Universal Serial Bus (USB) (not shown) may be used to provide an interface for an external device. Those skilled in the art will appreciate that in embodiments in which ED 102 is part of a data center, I/O interface 118 and Video Adapter 116 may be virtualized and provided through network interface 110.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

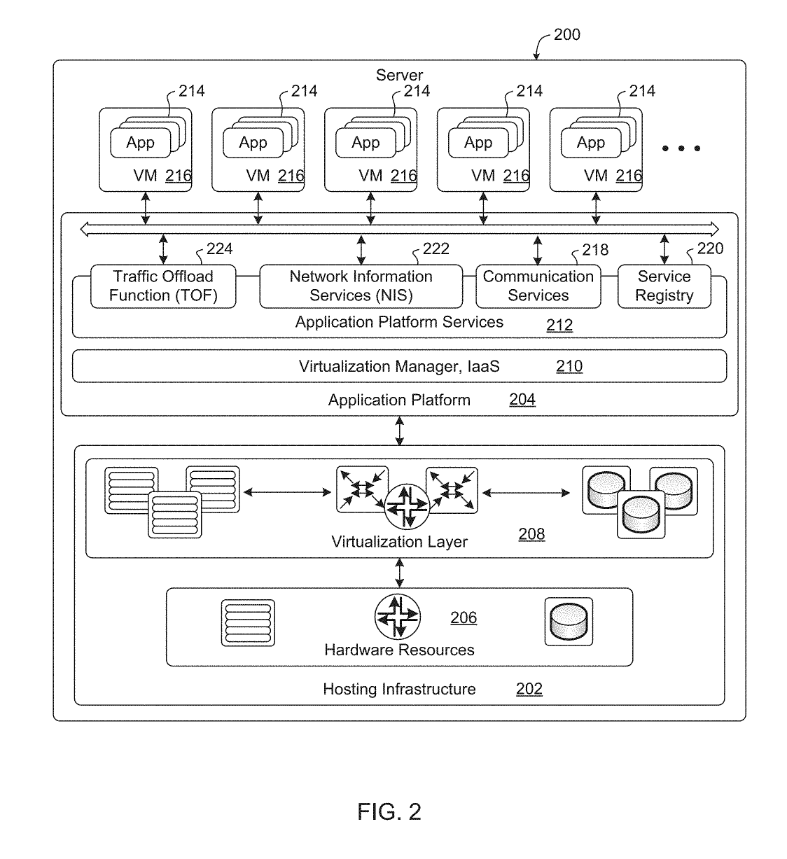

FIG. 2 is a block diagram schematically illustrating an architecture of a representative server 200 usable in embodiments of the present invention. It is contemplated that the server 200 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 2 shows a representative functional architecture of a server 200, it being understood that this functional architecture may be implemented using any suitable combination of hardware and software. It will also be understood that server 200 may itself be a virtualized entity. Because a virtualized entity has the same properties as a physical entity from the perspective of another node, both virtualized and physical computing platforms may serve as the underlying resource upon which virtualized functions are instantiated.

As may be seen in FIG. 2, the illustrated server 200 generally comprises a hosting infrastructure 202 and an application platform 204. The hosting infrastructure 202 comprises the physical hardware resources 206 (such as, for example, information processing, traffic forwarding and data storage resources) of the server 200, and a virtualization layer 208 that presents an abstraction of the hardware resources 206 to the Application Platform 204. The specific details of this abstraction will depend on the requirements of the applications being hosted by the Application layer (described below). Thus, for example, an application that provides traffic forwarding functions may be presented with an abstraction of the hardware resources 206 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol—LDAP). The virtualization layer 208 and the application platform 204 may be collectively referred to as a Hypervisor.

The application platform 204 provides the capabilities for hosting applications and includes a virtualization manager 210 and application platform services 212. The virtualization manager 210 supports a flexible and efficient multi-tenancy run-time and hosting environment for applications 214 by providing Infrastructure as a Service (IaaS) facilities. In operation, the virtualization manager 210 may provide a security and resource “sandbox” for each application being hosted by the platform 204. Each “sandbox” may be implemented as a Virtual Machine (VM) 216 that may include an appropriate operating system and controlled access to (virtualized) hardware resources 206 of the server 200. The application-platform services 212 provide a set of middleware application services and infrastructure services to the applications 214 hosted on the application platform 204, as will be described in greater detail below.

Applications 214 from vendors, service providers, and third-parties may be deployed and executed within a respective Virtual Machine 216. For example, MANagement and Orchestration (MANO) functions and Service Oriented Network Auto-Creation (SONAC) functions (or any of Software Defined Networking (SDN), Software Defined Topology (SDT), Software Defined Protocol (SDP) and Software Defined Resource Allocation (SDRA) controllers that may in some embodiments be incorporated into a SONAC controller) may be implemented by means of one or more applications 214 hosted on the application platform 204 as described above. Communication between applications 214 and services in the server 200 may conveniently be designed according to the principles of Service-Oriented Architecture (SOA) known in the art.

Communication services 218 may allow applications 214 hosted on a single server 200 to communicate with the application-platform services 212 (through pre-defined Application Programming Interfaces (APIs) for example) and with each other (for example through a service-specific API).

A service registry 220 may provide visibility of the services available on the server 200. In addition, the service registry 220 may present service availability (e.g. status of the service) together with the related interfaces and versions. This may be used by applications 214 to discover and locate the end-points for the services they require, and to publish their own service end-point for other applications to use.

Mobile-edge Computing allows cloud application services to be hosted alongside virtualized mobile network elements in data centers that are used for supporting the processing requirements of the Cloud-Radio Access Network (C-RAN). For example, eNodeB or gNB nodes may be virtualized as applications 214 executing in a VM 216. Network Information Services (NIS) 222 may provide applications 214 with low-level network information. For example, the information provided by NIS 222 may be used by an application 214 to calculate and present high-level and meaningful data such as: cell-ID, location of the subscriber, cell load and throughput guidance.

A Traffic Off-Load Function (TOF) service 224 may prioritize traffic, and route selected, policy-based, user-data streams to and from applications 214. The TOF service 224 may be supplied to applications 214 in various ways, including: A Pass-through mode where (either or both of uplink and downlink) traffic is passed to an application 214 which can monitor, modify or shape it and then send it back to the original Packet Data Network (PDN) connection (e.g. 3GPP bearer); and an End-point mode where the traffic is terminated by the application 214 which acts as a server.

As may be appreciated, the server architecture of FIG. 2 is an example of Platform Virtualization, in which each Virtual Machine 216 emulates a physical computer with its own operating system, and (virtualized) hardware resources of its host system. Software applications 214 executed on a virtual machine 216 are separated from the underlying hardware resources 206 (for example by the virtualization layer 208 and Application Platform 204). In general terms, a Virtual Machine 216 is instantiated as a client of a hypervisor (such as the virtualization layer 208 and application-platform 204) which presents an abstraction of the hardware resources 206 to the Virtual Machine 216.

Other virtualization technologies are known or may be developed in the future that may use a different functional architecture of the server 200. For example, Operating-System-Level virtualization is a virtualization technology in which the kernel of an operating system allows the existence of multiple isolated user-space instances, instead of just one. Such instances, which are sometimes called containers, virtualization engines (VEs) or jails (such as a “FreeBSD jail” or “chroot jail”), may emulate physical computers from the point of view of applications running in them. However, unlike virtual machines, each user space instance may directly access the hardware resources 206 of the host system, using the host systems kernel. In this arrangement, at least the virtualization layer 208 of FIG. 2 would not be needed by a user space instance. More broadly, it will be recognised that the functional architecture of a server 200 may vary depending on the choice of virtualisation technology and possibly different vendors of a specific virtualisation technology.

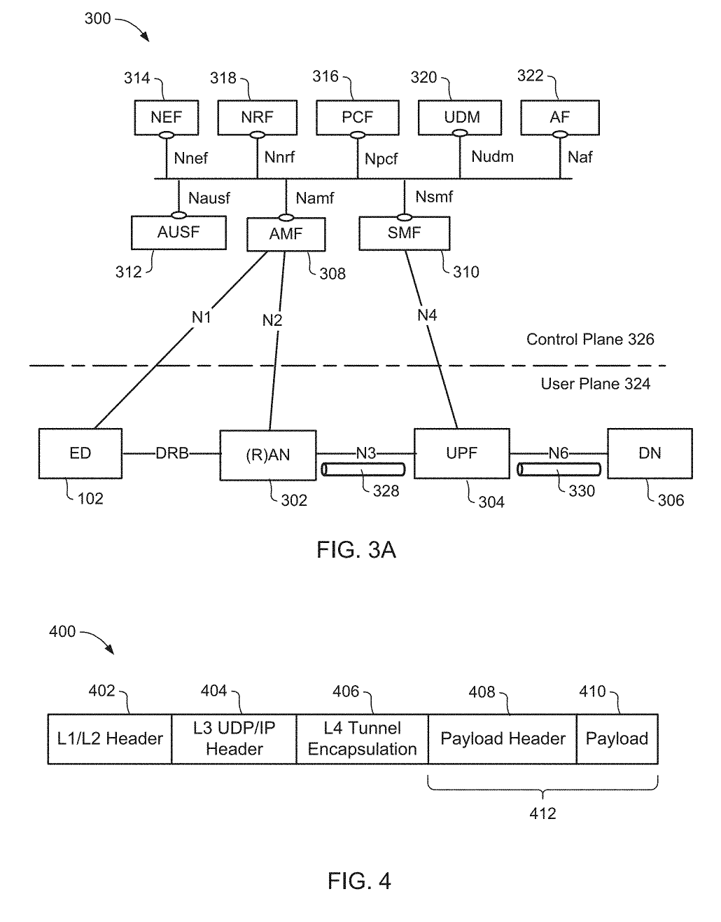

FIG. 3A illustrates a service-based architecture 300 for a 5G or Next Generation Core Network (5GCN/NGCN/NCN). This illustration depicts logical connections between nodes and functions, and its illustrated connections should not be interpreted as direct physical connections. ED 102 forms a radio access network connection with a (Radio) Access Network ((R)AN) node 302 (which may, for example, be an gNodeB (gNB)), which is connected to a User Plane (UP) Function (UPF) 304 such as a UP Gateway over a network interface providing a defined interface such as an N3 interface. UPF 304 provides a logical connection to a Data Network (DN) 306 over a network interface such as an N6 interface. The radio access network connection between the ED 102 and the (R)AN node 302 may be referred to as a Data Radio Bearer (DRB).

DN 306 may be a data network used to provide an operator service, or it may be outside the scope of the standardization of the Third Generation Partnership Project (3GPP), such as the Internet, a network used to provide third party service, and in some embodiments DN 306 may represent an Edge Computing network or resource, such as a Mobile Edge Computing (MEC) network.

ED 102 also connects to the Access and Mobility Management Function (AMF) 308 through a logical N1 connection (although the physical path of the connection is not direct). The AMF 308 is responsible for authentication and authorization of access requests, as well as mobility management functions. The AMF 308 may perform other roles and functions as defined by the 3GPP Technical Specification (TS) 23.501. In a service based view, AMF 308 can communicate with other core network control plane functions through a service based interface denoted as Namf.

The Session Management Function (SMF) 310 is a network function that is responsible for the allocation and management of IP addresses that are assigned to a UE as well as the selection of a UPF 304 (or a particular instance of a UPF 304) for traffic associated with a particular session of ED 102. The SMF 310 can communicate with other core network functions, in a service based view, through a service based interface denoted as Nsmf. The SME 310 may also connect to a UPF 304 through a logical interface such as network interface N4.

The Authentication Server Function (AUSF) 312, provides authentication services to other network functions over a service based Nausf interface.

A Network Exposure Function (NEF) 314 can be deployed in the network to allow servers, functions and other entities such as those outside a trusted domain to have exposure to services and capabilities within the network. In one such example, an NEF 314 can act much like a proxy between an application server outside the illustrated network and network functions such as the Policy Control Function (PCF) 316, the SMF 310, the UDM 320, and the AMF 308, so that the external application server can provide information that may be of use in the setup of the parameters associated with a data session. The NEF 314 can communicate with other network functions through a service based Nnef network interface. The NEF 314 may also have an interface to non-3GPP functions.

A Network Repository Function (NRF) 318, provides network service discovery functionality. The NRF 318 may be specific to the Public Land Mobility Network (PLMN) or network operator, with which it is associated. The service discovery functionality can allow network functions and UEs connected to the network to determine where and how to access existing network functions, and may present the service based interface Nnrf.

PCF 316 communicates with other network functions over a service based Npcf interface, and can be used to provide policy and rules to other network functions, including those within the control plane. Enforcement and application of the policies and rules is not necessarily the responsibility of the PCF 316, and is instead typically the responsibility of the functions to which the PCF 316 transmits the policy. In one such example the PCF 316 may transmit policy associated with session management to the SMF 310. This may be used to allow for a unified policy framework with which network behavior can be governed.

A Unified Data Management Function (UDM) 320 can present a service based Nudm interface to communicate with other network functions, and can provide data storage facilities to other network functions. Unified data storage can allow for a consolidated view of network information that can be used to ensure that the most relevant information can be made available to different network functions from a single resource. This can make implementation of other network functions easier, as they do not need to determine where a particular type of data is stored in the network. The UDM 320 may employ an interface, such as a UDM Front End (UDM-FE) to connect to a User Data Repository (UDR). The PCF 316 may be associated with the UDM 320 because it may be involved with requesting and providing subscription policy information to the UDR, but it should be understood that typically the PCF 316 and the UDM 320 are independent functions.

The PCF 316 may have a direct interface to the UDR. The UDM 320 can receive requests to retrieve content stored in the UDR, or requests to store content in the UDR. The UDM 320 is typically responsible for functionality such as the processing of credentials, location management and subscription management. The UDR may also support any or all of Authentication Credential Processing, User Identification handling, Access Authorization, Registration/Mobility management, subscription management, and Short Message Service (SMS) management. The UDR is typically responsible for storing data provided by the UDM 320. The stored data is typically associated with policy profile information (which may be provided by PCF 316) that governs the access rights to the stored data. In some embodiments, the UDR may store policy data, as well as user subscription data which may include any or all of subscription identifiers, security credentials, access and mobility related subscription data and session related data.

Application Function (AF) 322 represents the non-data plane (also referred to as the non-user plane) functionality of an application deployed within a network operator domain and within a 3GPP compliant network. The AF 322 interacts with other core network functions through a service based Naf interface, and may access network capability exposure information, as well as provide application information for use in decisions such as traffic routing. The AF 322 can also interact with functions such as the PCF 316 to provide application specific input into policy and policy enforcement decisions. It should be understood that in many situations the AF 322 does not provide network services to other NFs, and instead is often viewed as a consumer or user of services provided by other NFs. An application outside the 3GPP network, can perform many of the same functions as AF 322 through the use of NEF 314.

ED 102 communicates with network functions that are in the User Plane (UP) 324, and the Control Plane (CP) 326. The UPF 304 is a part of the CN UP 324 (DN 306 being outside the 5GCN). (R)AN node 302 may be considered as a part of a User Plane, but because it is not strictly a part of the CN, it is not considered to be a part of the CN UP 324. AMF 308, SMF 310, AUSF 312, NEF 314, NRF 318, PCF 316, and UDM 320 are functions that reside within the CN CP 326, and are often referred to as Control Plane Functions. AF 322 may communicate with other functions within CN CP 326 (either directly or indirectly through the NEF 314), but is typically not considered to be a part of the CN CP 326.

Those skilled in the art will appreciate that there may be a plurality of UPFs connected in series between the (R)AN node 302 and the DN 306, and multiple data sessions to different DNs can be accommodated through the use of multiple UPFs in parallel.

User Plane (UP) packets flows to and from a particular ED 102. UP packets are normally routed between the (R)AN node 302 connected to the ED 102, and the DN 306 using General Packet Radio Service (GPRS) Tunneling Protocol (GTP) tunnels 328 and possibly IP-based tunnel 330 established through the N3 and N6 interfaces, respectively. In some examples, connections between (R)AN node 302 and a UPF 304 would make use of GTP tunnel 328. Connections between the illustrated UPF 304 and other unillustrated UPFs would also make sure of a GTP tunnel. Upon leaving the CN UP, a packet may make use of an IP-based connection between the UPF and the DN 306 instead of a GTP tunnel, especially if DN 306 is outside the domain of the operator. Typically, a GTP tunnel 328 is established between the (R)AN node 302 and the UPF 304 for each Radio Bearer between the ED 102 and the RAN node 302. This allows for a one-to-one relationship between Radio Bearers and GTP tunnels. Where there is a second UPF, there would usually be a corresponding GTP tunnel between the UPFs for each GTP tunnel between the (R)AN node 302 and the UPF 304. This results in each radio bearer being associated with a set of GTP tunnels forming a path through the CN UP. Each GTP tunnel may support multiple PDU sessions, and packet flows with multiple different QoS requirements. Packet flows within a GTP tunnel, such as tunnel 328, having the same QoS requirements may be grouped together as a QoS Flow, which may be identified by a given QFI. The QFI can therefore be used for queuing and prioritization of packet forwarding through the GTP tunnels 328 and 330.

At the time of PDU session establishment, the SMF 310 typically provides one or more QoS Profiles to the (R)AN node 302. These QoS Profiles contain QoS parameters for controlling the forwarding of packets having various QoS requirements. Example QoS parameters that may be included in a QoS Profile may include: 5G QoS Identifier (5QI), Allocation and Retention Priority (ARP), Reflective QoS Attribute (RQA), Guaranteed Flow Bit Rate (GFBR), Maximum Flow Bit Rate (MFBR), and Notification Control parameters.

At the time of PDU session establishment, the SMF 310 typically provides one or more QoS Rules to the ED 102. These QoS Rules contain information for controlling the forwarding of packets having various QoS requirements. Example information that may be included in a QoS Rule may include: QoS Rule Identifier; QFI, one or more packet filters and precedence values, QoS parameters (such as 5G QoS Identifier (5QI), Guaranteed Bit Rate (GBR), Maximum Bit Rate (MBR), etc.). During run-time, the ED 102 may insert the QFI into UpLink (UL) packets prior to sending them through the RB to the (R)AN node 302. Upon recipe of the UL packet from the ED 102, the (R)AN node 302 may use the QFI of the packet and the Qos Profiles to control queueing and transmission of the packet to the UPF 304.

As may be appreciated, there can be more than one QoS rule associated with a given QoS Flow. These QoS rules may contain the same QFI. In some cases, a Default QoS rule may be defined. The Default QoS rule may be the only QoS rule of a PDU session that does not contain a packet filter.

It should be appreciated that there may be multiple UPFs in the user plane 324 for carrying packets from the RAN 302 to the DN 306. FIG. 3B illustrates such a configuration of the user plane 324, with a plurality of UPFs 304A, 304B interconnected via an N9 interface 329. There is a one-to-one mapping between the N3 and N9 interfaces. Accordingly, although examples will be discussed for packets going from the N3 interface 328 to the N6 interface 330, it should be appreciated that the principles discussed herein also apply to packets going between N3 and N9 interfaces, and between N9 and N6 interfaces.

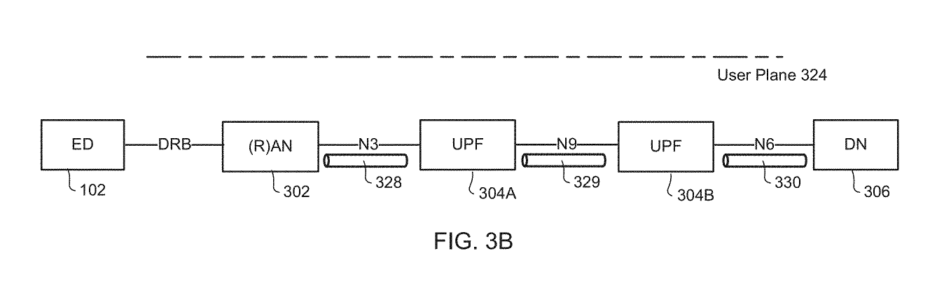

FIG. 4 is a block diagram illustrating a User-Plane Protocol Data Unit (UP-PDU) 400 used to transport User-Plane traffic through a tunnel in the core network. In some embodiments, the tunnel may be a GTP tunnel such as tunnel 328 described above with reference to FIG. 3. In general terms, the PDU 400 includes an L1/L2 header 402, a L3 UDP/IP header 404, an L4 Tunnel Encapsulation information (also referred to as an L4 tunnel encapsulation header) 406, and a payload 412 that may include at least a Payload header 408 and a Payload 410.

The L1/L2 header 402 is used to route traffic on specific media, such as optical cable or wireless link. Those skilled in the art will appreciate that from the perspective of an L1/L2 entity, the L3 header 404, L4 encapsulation information 406 and the payload 412 may all appear to be a payload.

The L3 UDP/IP header 404 typically contains IP addresses and UDP port numbers of the packet source and destination, which will normally be the UPF 304 and the (R)AN node 302. From the perspective of an L3 entity, the L4 tunnel encapsulation information 406 and the payload 412 may all appear to be a payload.

The L4 Tunnel Encapsulation information will typically include tunnel specific information such as a Tunnel Endpoint Identifier (TEID) identifying the GTP tunnel 328, as well as Quality of Service (QoS) Flow Identity (QFI) and RQI information of packet flows within the GTP tunnel 328. Where a non-GTP tunnel is employed, other tunnel identifying information may be employed in place of the GTP TEID.

The Payload header 408 and Payload 410 comprise the application-layer Protocol Data Unit (PDU) 412 that is sent and received by an application executing on the ED 102. Typically, the QoS requirement of the application-layer PDU 412 is determined by the application executed in the ED 102, and will normally be indicated by one or more QoS parameters inserted in the Payload header 408.

The 5G standards currently provide support for so-called “structured” PDU sessions (i.e. those in which the application-layer PDUs 412 are any one of IPv4, IPv6 and Ethernet packets). As a result, when the application-layer PDU 412 conforms to one of the IPv4, IPv6 and Ethernet standards, the UPF 304 can analyse the Payload header 408 to read a QoS parameter(s) stored within the payload header and determine the appropriate QFI for the packet. Those skilled in the art will appreciate that in some part, this is due to the knowledge of where to start reading the QFI information based on a known structure of the other headers in the packet or PDU 400. A wide variety of other PDU formats can be transported through the 5G network, using the UP-PDU 400, but these are treated as “unstructured”. Among other things, the unstructured nature of such packets means that the UPF 304 cannot analyse the Payload header 408 to read its QoS parameter, and so cannot determine an appropriate QFI for the packet. Although it is possible to establish different PDU sessions for application-layer PDU flows having respective different QoS requirements, but this solution increases management signalling and overhead, which is undesirable. It is better to have one Unstructured PDU Session that can support multiple QoS flows. Four example solutions, referred to as solution 1, solution 2, solution 3 and solution 4 are discussed below.

Embodiments according to Solution 1 will now be discussed. Generally, for solution 1, the header information of the N6 tunnel 330, such as an IP tunnel, is used to identify different QoS flows in the tunnels 328 and 330. Example implementations of this technique will now be discussed.

Embodiment 1: Assigning a set of IP Addresses or IP Prefixes to the N6 interface for an unstructured PDU session, and mapping the assigned set of IP Addresses or IP Prefixes to a corresponding set of QoS Flows. For example, the Source IP Address used for UpLink (UL) packets sent from the UPF 304 to the DN 306 (or an Application Server accessed through the DN 306) may be mapped to a given QoS Flow Identifier (QFI) and so may be used by the UPF 304 to control the forwarding of UL packets. The Application Server may subsequently use the source IP Address of received UL packets as the destination IP Address for the Downlink (DL) packets sent to the UPF 304. This ensures that the DL packets are associated with the same QFI as the UL packets, and so are handled by the UPF 304 in accordance with the appropriate QoS Policy.

Embodiment 2: Assigning a set of Flow Labels to a PDU session, and mapping the assigned set of Flow Labels to a corresponding set of QoS Flows. For example, each QoS flow may have a unique Flow Label that is set for the UpLink (UL) packets sent from the UPF 304 to the DN 306 (or an Application Server accessed through the DN 306). The Application Server may subsequently use the same Flow Label for the DL packets sent to the UPF 304, which ensures that the DL packets are associated with the same QFI as the UL packets, and so are handled in accordance with the appropriate QoS Profile.

Embodiment 3: Assigning a set of Traffic Classes to a PDU session, and mapping the assigned set of Traffic Classes to a corresponding set of QoS Flows. For example, each QoS flow may have a unique Traffic Class that is set for the UpLink (UL) packets sent from the UPF 304 to the DN 306 (or an Application Server accessed through the DN 306). The Application Server may subsequently use the same Traffic Class for the DL packets sent to the UPF 304, which ensures that the DL packets are associated with the same QFI, and so are handled in accordance with the appropriate QoS policy.

Embodiment 4: The UPF 304 can insert QoS Flow information into an Extension Header of UpLink (UL) packets sent from the UPF 304 to the DN 306 (or an Application Server accessed through the DN 306). For example, QoS Flow information, such as the QFI, can be inserted into an Extension Header of the UL packets at the UPF 304. The Application Server may subsequently insert the same QoS Flow information into the Extension header of DL packets sent to the UPF 304, which ensures that the DL packets have the same QFI, and so are handled in accordance with the appropriate QoS policy.

Embodiment 5: Utilizing an UDP port of UPF 304 to send UL packets of a set of QoS flows to the DN 306. In the DL, the Application Server will send DL packets using the same source UDP port of the UL packets so that the UPF 304 can map the DL packets to the same QoS flows.

For each embodiment of solution 1, the methods can therefore include receiving downlink packets from N6 interface having the tunnel header information associated with the QoS flows and transmitting the downlink packets to N9 interface or N3 interface in accordance with the QoS flow handling rules of the unstructured PDU session. In other words, the UPF 304 can receive the downlink packets from the N6 interface, and determine the N3 (or N9) packet header and treatment based on the approaches described above with respect to the UL. For example the UPF receives a packet of the unstructured PDU session over the N6 interface. The UPF reads the header information of the received DownLink PDU packet of the unstructured PDU session. The UPF identifies a Packet Detection Rule associated with the header information and transmits the DownLink PDU packet using the identified Packet Detection Rule. Optionally, the transmission of the DownLink PDU packet may follow packet handling rules, such as packet forwarding rules, usage reporting rules, and QoS enforcement rules. In some embodiments, the UPF identifies the Packet Detection Rule according to the approach used in the previously discussed embodiments for the UL. In some embodiments, the UPF transmits the DL PDU by removing N6 header information and creating an N3 or N9 packet header using a Downlink mapping between N6 tunnel header information and the QFI of the N3 interface or N9 interface, and transmits the Downlink PDU using the N3 or N9 packet header. In some embodiments, the Packet Detection Rules are received from the SMF 310.

Further examples of Embodiment 1 are described below by way of representative procedures for Unstructured PDU Session Establishment, UpLink (UL) Transmission; DownLink (DL) Transmission and Session Modification.

### Unstructured PDU Session Establishment

When the ED 102 requests an unstructured PDU session, the ED 102 may request (or otherwise indicate the need or desire for) multiple QoS flows, in the same manner as it would for a structured PDU session.

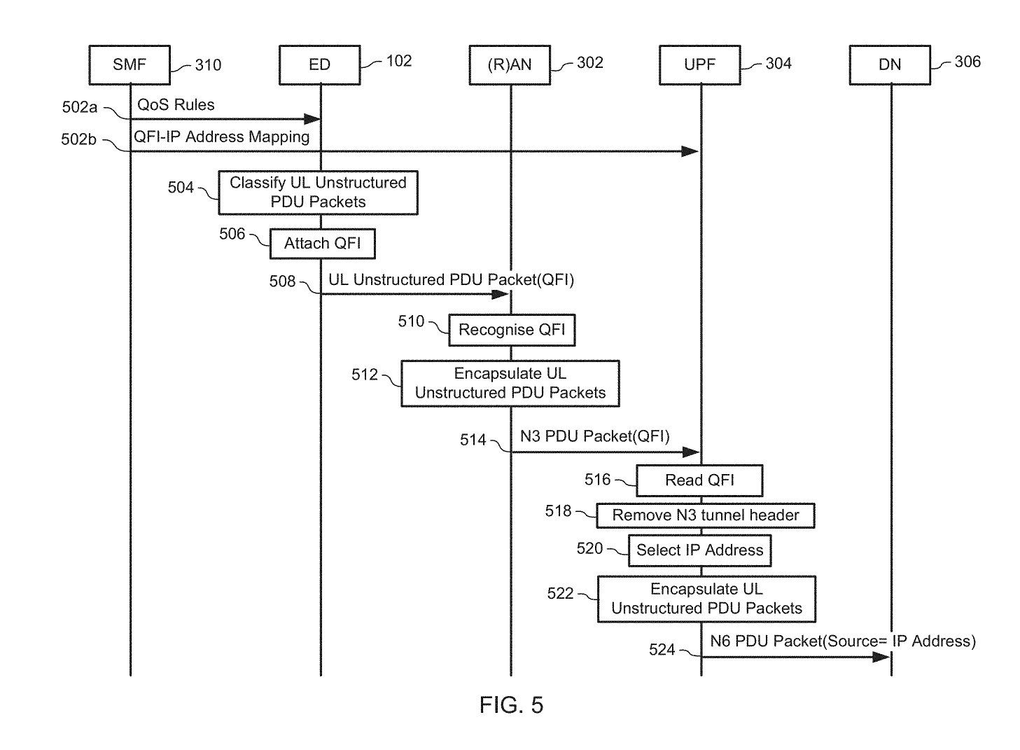

In reply to the request from the ED 102, the SMF 310 may send one or more QoS rules to the ED 102 (e.g. via the AMF 308 and the N1 interface). Each QoS rule may contain QoS parameters for one QoS flow, and a corresponding QFI. Example information that may be included in a QoS Rule may include: QoS Rule Identifier; QFI, no or one or more packet filters and precedence values, QoS parameters (such as 5QI, Guaranteed Bit Rate (GBR), Maximum Bit Rate (MBR), etc.). In case of unstructured PDU session, the packet filter may include only the UDP source port to be used by the ED 102 to send the UP packets. The SMF 310 may also assign (and optionally transmit Packet Detection Rules including an indication of) a set of IP addresses or IP prefixes for use by the UPF 304 to identify QoS flows within the requested unstructured PDU session. In the case of IPv4 application layer PDUs 412, the assigned IP addresses may be IPv4 addresses. In the case of IPv6 application layer PDUs 412, the assigned IP addresses may be IP prefixes. In some embodiments, the SMF 310 may generate a mapping between the assigned set of IP addresses and QoS flows (or QFIs) of the requested unstructured PDU session. This mapping may then be provided to the UPF 304 for subsequent use during runtime of the unstructured PDU session as part of sending the Packet Detection Rules. In other embodiments, the SMF 310 may send the assigned set of IP addresses to the UPF 304, then the UPF 304 may subsequently generate the mapping between the assigned set of IP addresses and QoS flows (or QFIs) of the requested unstructured PDU session. These steps are shown as steps 502a and 502b of FIG. 5, as discussed below.

The SMF 310 may also send one or more preconfigured or dynamic QoS Profiles to the (R)AN node 302 (e.g. via the AMF 308 and the N2 interface) for the unstructured PDU session, in the same manner as it would for a structured PDU session.

Currently, 5G Phase I (Rel 15) allows for a single default QoS rule, in which there is a single QFI and no packet filters. In contrast, in the above described technique, default QoS rules may have multiple QFIs. In some embodiments, some QoS Rules may have packet filters, while others do not. Preferably, the ED 102 includes software or firmware configured to map UL packets to the appropriate QFI.

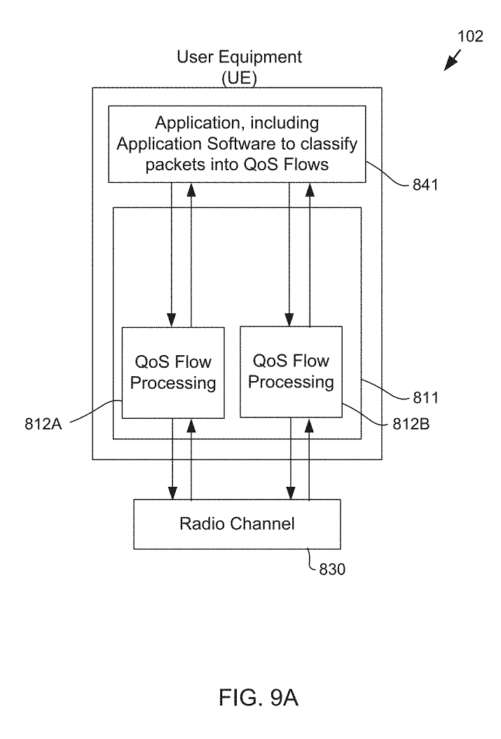

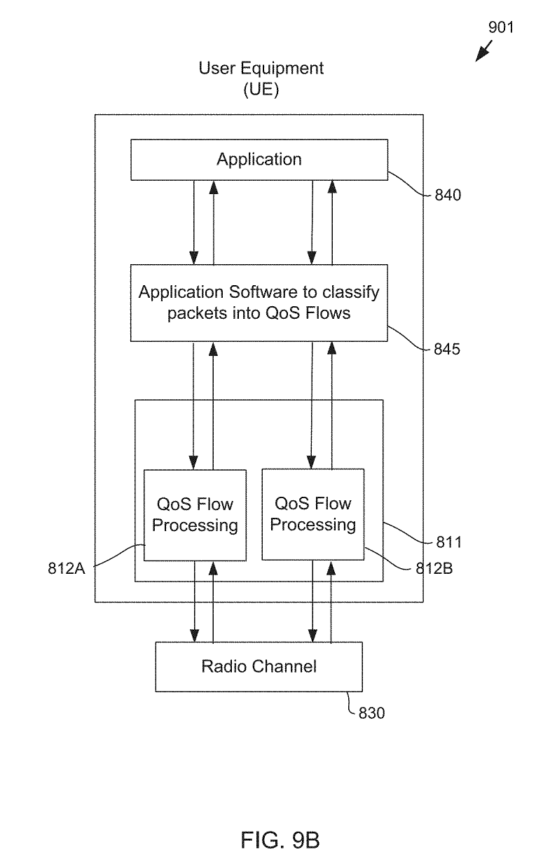

In Solutions 1 and 2 and variations using other IP headers over the N6 interface, the SMF 310 may provide the ED 102 with multiple QoS rules without packet filters. The ED 102 may also have one or more preconfigured QoS rules without packet filters, as will be discussed in more detail below with reference to FIGS. 8, 9A and 9B.

The ED 102 may use its own logic (software or firmware) to perform packet classification without packet filters and map packets with QFI, as will be discussed below with reference to FIGS. 8, 9A and 9B.

### UpLink (UL) Transmission

FIG. 5 is a call flow diagram illustrating a representative UpLink (UL) PDU transmission process for Solution 1. In the example of FIG. 5, the SMF 310 may assign (at 502a) QoS rules to the ED 102; one of the provided QoS rules may be a default QoS rule, which does not specify an Service Data Flow (SDF) filter. The SMF 310 may also assign (and transmit at 502b) Packet Detection Rules including a QFI-IP Address mapping to the UPF 304. As described above, the QFI-IP Address mapping may provide a one-to-one mapping between a set of IP Address or address prefixes and QFIs of one or more QoS flows of the unstructured PDU session. In some embodiments, these initial steps (502a and 502b) may be performed as part of establishing the unstructured PDU session, rather than UpLink transmission, per se. a process of establishing PDU Session. The ED 102 may use the QoS rules to classify (at 504) UL unstructured PDU packets into QoS Flows, and may attach (at 506) the applicable QFI to the UL unstructured PDU packets, in accordance with the QoS rule(s) provided by the SMF 310. Attaching the applicable QFI may take the form of transmitting 506 an unstructured UL packet which includes a QFI indication. Additionally, the (R)AN 302 may establish one Data Radio Bearer (DRB) for each QoS flow. In this case, the ED 102 may skip step 506. The ED 102 may then send the UL unstructured PDU packets (at 508) to the (R)AN node 302. Upon receipt of a UL unstructured PDU packet from the ED 102, the (R)AN node 302 may recognize its QFI (at 510) and process the UL unstructured PDU packet (at 512) according to the corresponding QoS profile. For example, the (R)AN node 302 may encapsulate the UL unstructured PDU packets in N3 GTP tunnel format, which includes the QFI, and transmit (at 514) the encapsulated unstructured PDU packet to the UPF 304 via an N3 GTP tunnel 328. Transmitting the encapsulated unstructured PDU packet in 514 may take the form of transmitting to the UPF 304 a packet over the N3 interface that has been encapsulated by attaching a GTP header.

When the UPF 304 receives an encapsulated unstructured PDU packet from the (R)AN node 302, the UPF 304 may read (at 516) the QFI of the received packet. The UPF 304 may then remove (at 518) the N3 tunnel header information from the encapsulated packet, and select (at 520) a IP Address for the UL PDU packet based on the QFI of the received packet and the QFI-IP Address mapping provided by the SMF 310. In the illustrated embodiment, the IP address selected in step 520 is a source IP address from which the UPF 304 will transmit packets towards the DN 306. The UPF 304 may then encapsulate (at 522) s the UL PDU packet into N6 IP tunnel format using the selected IP Address as the Source IP Address of the N6 encapsulated UL PDU packet. The UPF 304 may then send the N6 encapsulated UL PDU packet to the DN 306 through the N6 IP tunnel 330.

Those skilled in the art will appreciate that in the above discussion, the UPF 304 selects, on the basis of the QFI of a packet, an IP address from which to transmit a packet towards the DN 306. The transmitted packet is based on the received packet, but the header information (typically the GTP header information) can be removed. The UPF 304 may have a plurality of different IP addresses. Routing between the UPF 304 and DN 306 can be done in accordance with the address from which the UPF 304 transmits. In a simple configuration, a first IP address can be used for best effort traffic, while a second IP address can be used for traffic to be treated with a particular QoS. It should also be understood that in some embodiments, the DN 306 may have a plurality of IP addresses at which it can receive data, each of which is associated with a different QoS. In such an embodiment, the UPF 304 would transmit the encapsulated unstructured PDU packet to the IP address selected in 520. It is also possible that both the UPF 304 and the DN 306 have pluralities of IP addresses. In some embodiments, each side of the communication may have different QoS characteristics or parameters associated with the addresses. For example, the UPF may have different addresses each of which is associated with a latency, while the DN may have different addresses each of which is associated with a jitter parameter. Based on the QFI, the UPF 304 can select appropriate source and destination addresses.

### DL Transmission

An advantage of mapping IP Address or address prefixes to QFI, as described above, is that DownLink (DL) unstructured PDU packet flows can be handled using the same processes as structured PDU packet flows. For example, an Application Server in the DN 306 may send a DL unstructured PDU packet to the UPF 304 via the N6 IP tunnel 330 (e.g. to the UPF 304 using the same IP address selected in 520). Following conventional techniques, the destination IP address of the DL unstructured PDU packet will typically be the source IP address of previously received packets from the UPF 304. Upon receipt of the DL unstructured PDU packet from the DN 306, the UPF 304 can read the destination IP address and use it to map the DL unstructured PDU packet to the appropriate QoS flow, before forwarding the DL unstructured PDU packet to the ED 102 based on the applicable QoS policy in a conventional manner.

### Adding QoS Flows

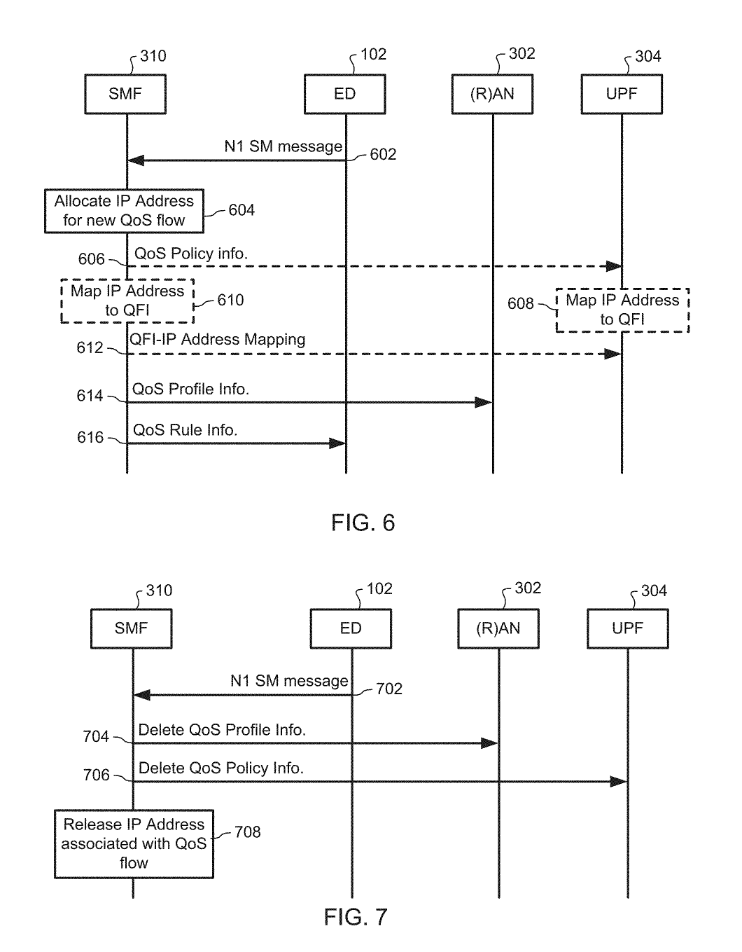

FIG. 6 is a call flow diagram illustrating a representative process for adding a QoS flow to an existing unstructured PDU session in Solution 1. In the example of FIG. 6, when the ED 102 is adding a new QoS flow for an existing unstructured PDU session, the ED 102 sends an N1 session modification message (at 602) to the SMF 310 to request the addition of the new QoS flow to the existing unstructured PDU session. Following receipt of the session modification message carried on the N1 interface from the ED 102, the SMF 310 may allocate (at 604) a new IP address or IP prefix for the new QoS flow.

The SMF 310 then transmits the new QoS flow information to the UPF 304. In some embodiments, the SMF 310 may send QoS policy information (at 606) as part of the Packet Detection Rules to the UPF 304, which may include a new QoS rule and the assigned IP address (or prefix) to be used as part of the SDF filter for UL and DL packets sent to or from DN (which may be transmitted over the N6 tunnel 330). Following receipt of the QoS policy information, the UPF 304 may generate (at 608) an IP address-QFI mapping pertaining to the new QoS flow. In other embodiments, the SMF 310 may generate (at 610) the IP address-QFI mapping pertaining to the new QoS flow, and send it (at 612) to the UPF 304. In some embodiments the UPF 304 may be instructed in 606 to generate the QFI-IP address mapping, and will then transmit the mapping to the SMF 310. Optionally, in some embodiments, the QoS policy information sent by the SMF 310 (at 606) may include the new QoS rule (for example a QoS enforcement rule) and the Packet Detection Rules. It can be understood, the term “QoS Rule” may be used as one of QoS handling rules for the ED, and the term QoS policy or QoS enforcement rule may be used as one of the QoS handling rules sent by the SMF 310 to the UPF 304, and used by the UPF 304.

The SMF also sends (at 614) the QoS Profile information for the new QoS flow to the (R)AN node 302 so that the (R)AN node 302 can process the UL and DL packets according to the QFI.

The SMF also sends (at 616) the QoS Rule information for the new QoS flow to the ED 102 so that the ED 102 can classify UL packets and attach the appropriate QFI.

### Removing QoS Flows

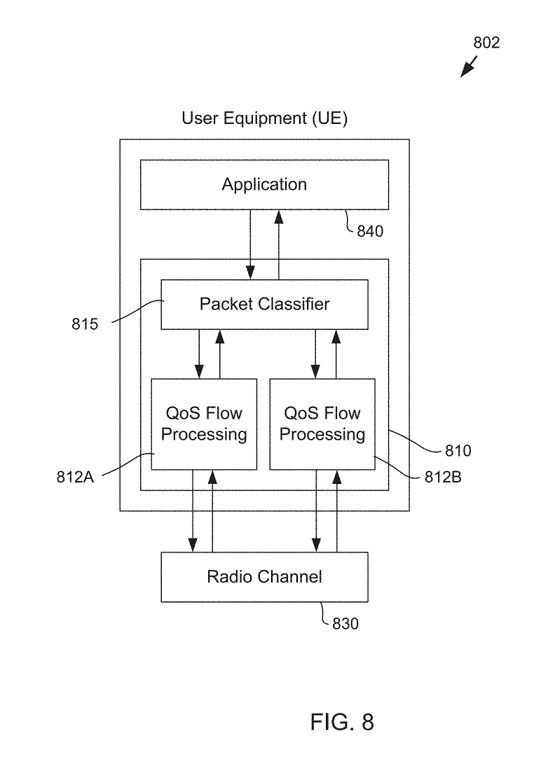

FIG. 7 is a call flow diagram illustrating a representative process for removing a QoS flow to an existing unstructured PDU session in Solution 1. In the example of FIG. 7, the ED 102 may send (at 702) an N1 session modification request message to the SMF 310 to request removal of the QoS flow; other control functions, such as PCF 316, AF 322, and (R)AN 302, may also request the SMF 310 to remove a QoS flow. The SMF may also decide itself to remove a QoS flow. Following receipt of the N1 session modification request message from the ED 102 (or any of the above described events), the SMF 310 may send (at 704) a request to the (R)AN node 302 to delete its QoS policy information pertaining to the QoS flow being removed. Similarly, the SMF 310 may send (at 706) a request to the UPF 304 to delete its QoS policy information pertaining to the QoS flow being removed. Finally, the SMF 310 may release (at 708) the IP address or IP prefix allocated to the QoS flow, so that this IP address information is available for future allocation to other QoS flows. The SMF may send an N1 SM message to the UE to confirm the removal of QoS Flow. If the removal of the QoS flows are initiated by a node other than ED 102, SMF 310 may provide an instruction to ED 102 to delete/release policy information.

### Solution 2

Embodiments according to Solution 2 will now be discussed.

One IP address is used for the N6 IP point-to-point tunnel. The QoS Flow ID (QFI) is indicated by a field in the extension header of the IP packet (not a data field) sent over N6 IP tunnel 330. In this solution any or all of the following modifications may be implemented using the above discussed embodiments as a baseline. The SMF 310 assigns (and transmit information about) only 1 IP address or IP prefix for N6 IP point-to-point tunnel 330 as is conventionally specified for unstructured PDU sessions. The IP header may have an extension header indicating at least one of Flow Label and Traffic Class. The UPF 304 may assign multiple UDP ports for the connection with DN 306, each port associated with a QoS flow. In some embodiments, there is a 1:1 mapping between ports and QoS flows. For each QoS flow of an unstructured PDU session, the SMF 310 may instruct the UPF 304 to map a QFI and one of the IP header information, including the extension header, Flow Label, Traffic Class, or UDP port of UL packets send through the N6 IP tunnel 330, as part of the SDF filter. The Application Server (in, or accessible through) the DN 306 can read the information in the IP header of received UL packet (from 5G network) and inserts this same IP header information into DL packet sent to the UPF 302. The UPF 302 can receive DL packets, and read the IP header to identify the appropriate QoS Flow. If the IP header information of the received DL packet is valid, the UPF 304 may map the DL packet to the QoS flow and encapsulate the DL packets in N3 tunnel format and sends it to (R)AN node 302 according to the QoS policy parameters.

### Solution 3

In a conventional 5G network, there is a one-to-one relationship between N3 tunnels 328 and Data Radio Bearers. In this solution, N3 tunnels 328 are shared between multiple Data Radio Bearers, and (potentially) multiple EDs 102. In this case, each shared N3 GTP tunnel 328 may be associated with a respective one QoS Flow, and be used to transport UL and DL unstructured PDU packets in accordance with that QoS Profile of the QoS flow.

Each shared N3 tunnel 328 may be mapped to a corresponding shared N6 tunnel.

IP Header fields (such as Source IP Address/Prefix, or Flow Label, or QoS Mask (DSCP), or extension header) of the N6 tunnel 330 may be mapped to QFI of the shared N3 GTP tunnel 328.

It should be understood that any or all of the above information discussed with respect to this particular solution may be applied to the earlier described details of the other solutions, using embodiments of the previously discussed solutions as a baseline where appropriate.

### Packet Filter for Solutions 1, 2, 3

For an unstructured PDU session type, the Packet Filter Set may support packet filtering based on any suitable combination of N6 tunnel parameters, such as:
Source/destination IP address or IPv6 prefix of N6 tunnel.
Source/destination port number of N6 tunnel if a transport protocol is used in N6 tunnel.
Protocol ID of the protocol above IP/Next header type of N6 tunnel.
Type of Service (TOS) (IPv4)/Traffic class (IPv6) and Mask of N6 tunnel.
Flow Label (IPv6) of N6 tunnel.
Security parameter index of N6 tunnel.
QFI information in Extension Header.

A person skilled in the art may combine 3GPP TS 23.501 especially clause 5.7.6 to the embodiments of the present specification, for example, the person skilled in the art should appreciate the following. A value left unspecified in a filter may match any value of the corresponding information in a packet. An IP address or Prefix may be combined with a prefix mask. Port numbers may be specified as port ranges.

Unlike an IP PDU Session type, (where the IP header is the header of packet and it is not removed at the UPF 304), for Unstructured PDU Session type, the UPF 304 removes the N6 IP tunnel header and encapsulates the unstructured PDU packet in the N3 tunnel format.

It should be understood that any or all of the above information discussed with respect to this particular solution may be applied to the earlier described details of the other solutions, using embodiments of the previously discussed solutions as a baseline where appropriate.

### Solution 4

The ED 102 may use UDP protocol or other transport layer protocols. In case of UDP, the ED 102 may use a Source UDP port and/or Destination UP port for a QoS flow. The mapping between Source and/or Destination UDP port to QoS flow may be known by the (R)AN node 302 or other UPF functions in the Core Network (CN). The CN may also instruct the ED 102 about packet filters, which may be used to map between the QoS Flow Identifier (QFI) and the Source and/or Destination UDP port numbers used by ED 102. In some embodiments, the ED 102 may not need to use a QoS Flow Indicator in the Data Radio Bearer. The (R)AN node 302 may provide 1 DRB for each QoS flow. Alternatively, the (R)AN node 302 may need to read the Source and/or Destination UDP port number to identify QoS Flow and map the packets to the N3 tunnel QFI.

The UPF 304 may read the Source and/or Destination UDP port in the header of DL packets to classify PDU packets into QoS Flows to send to or receive from N6 interface.

New types of PDU session may be defined, each of which may be related to the particular transport layer protocol used by ED 102. For example, if the transport layer protocol is UDP, the PDU session type may be UDP PDU Session. The ED 102 may send request to the CN (e.g. via the (R)AN node 302) to establish a UDP PDU Session. Alternatively, the ED 102 may send request to the CN to establish an Unstructured PDU Session. In response to the request, the CN may check the ED's subscription information, which may have transport protocol information of the ED 102, for example UDP protocol. The CN may then provide QoS rules to the ED 102 and QoS profiles to the (R)AN 302, in which the mapping between QoS Flow and UDP port is specified. Alternatively, the mapping between QFI and UDP port may be pre-configured in the ED 102. The CN may also provide the QoS profiles and QoS policies to the (R)AN node 302 and UPF 304.

It should be understood that any or all of the above information discussed with respect to this particular solution may be applied to the earlier described details of the other solutions, using embodiments of the previously discussed solutions as a baseline where appropriate.

### Packet Filter for Solution 4

If the ED 102 employs UDP protocol, such as in some applications using Constrained Application Protocol (CoAP) and UDP protocol, the Packet Filter at the ED 102 may use UDP Source and/or Destination port numbers to classify packets into QoS flows. For Unstructured PDU Session type, the Packet Filter Set at the UPF 304 may support packet filtering based on any suitable combination of N6 tunnel parameters and/or UDP Source/Destination port numbers in DL PDU packets, including:
Source/destination IP address or IPv6 prefix of N6 interface.
UDP Source/destination port numbers in the transport layer header of DL unstructured PDU packets.
Protocol ID of the protocol above IP/Next header type of N6 interface.
Type of Service (TOS) (IPv4)/Traffic class (IPv6) and Mask of N6 interface.
Flow Label (IPv6) of N6 interface.
Security parameter index of N6 interface

A person skilled in the art may combine 3GPP TS 23.501 especially clause 5.7.6 to the embodiments of the present specification, for example, the person skilled in the art should appreciate the following. A value left unspecified in a filter may match any value of the corresponding information in a packet. Further, An IP address or Prefix may be combined with a prefix mask. Further, Port numbers may be specified as port ranges.

A person skilled in the art should appreciate that, unlike for an IP PDU Session type (where the IP header is the header of the packet and is not removed at UPF 304), for an Unstructured PDU Session type, the UPF 304 removes the N6 IP tunnel header and encapsulates the PDU packet in N3 tunnel format.

### IP Address Management

Since the SMF 310 assigns one or several IP Address(es) or IP Prefix(es) to each unstructured PDU session, the IP Address(es) or IP Prefixe(es) could be statically or dynamically assigned to the N6 interface.

The IP Address assignment method could be selected according to an agreement between Mobile Network Operator and Application provider. The PCF 316 or UDM 320 may keep this information.

If the IP Address/Prefix is statically assigned, the SMF 310 may not release the IP Address/Prefix when the ED 102 becomes CM-IDLE or RRC-INACTIVE state.

If the IP Address/Prefix is dynamically assigned, the SMF 310 may notify the UPF 304 to release the IP Address/Prefix when the AMF 308 notifies the SMF 310 that the ED 103 has entered CM-IDLE or RRC-INACTIVE state.

New IP Address(es)/Prefix(es) for N6 interface may be assigned to the UPF 304 by the SMF 310 when the ED 102 enters the CM-CONNECTED state from CM-IDLE state or RRC-CONNECTED state from RRC-INACTIVE state.

As discussed above, the ED 102 have one or more preconfigured QoS rules without packet filters, for use with unstructured PDU sessions. FIG. 8 illustrates an example of an Electronic Device (for example a UE) which utilizes packet filters for structured PDU sessions. UE 802 includes at least one radio unit for communicating with a mobile network, for example 3GPP Network interface module 810 and at least an application module 840. The 3GPP Network interface module 810 sends and receives the radio signal carrying user plane data of QoS flows to and from the radio channel 830. Note that the control signaling, for example radio control signaling to be exchanged with the (R)AN 302 and N1 interface signaling to be exchanged with the CN, is also sent from or received by the UE but there is another software module to process the signaling; this module is omitted in FIG. 8 for simplicity. The 3GPP Network interface module 810 includes QoS Flow processing modules 812A and 812B, each processing different QoS flows. The 3GPP Network interface module 810 also includes Packet Classifier 815 for classifying packets and directing them to the appropriate QoS flow processing module 812A, 812B according the QoS rules associated with the PDU session. Packets are transmitted between the Application 840 and Packet classifier 815.

FIGS. 9A and 9B illustrate embodiments in which packet classification into QoS flows is performed using an application software. In the Embodiment of FIG. 9A, the electronic device 102 includes Application software module 841 which is configured to classify packets into QoS flows. Accordingly 3GPP Network interface module 811 is illustrated to include QoS flow processing modules 812A, 812B, but is omitting the packet classifier of FIG. 8. It should be appreciated that this illustration is an abstraction to highlight differences in processing of unstructured PDU packets compared to structured PDUs. In some cases ED 102 can be a specialized device, for example a utility meter or other Internet of Things (IoT) device using Machine Type Communication which only utilizes unstructured PDUs. It should be appreciated that a UE may have a hybrid configuration which uses the packet classifier 815 for structured PDUs and Application software module 841 for unstructured PDUs. FIG. 9B illustrates an alternative, which does not require changes to the application software 840, and instead includes Application software module 845 which is configured to classify packets into QoS flows for one or multiple application software modules 840. In another implementation, there can be multiple Application software module 845, each module is associated with one Application software module 840 to perform packet classification. In FIG. 9B, Application software module 845 acts as an interface between the Application software 840 and the 3GPP Network interface module 811. In either case, the application software 841, 845 is capable of receiving multiple QoS Rules for one unstructured PDU Session from the mobile network. The application software module 841, 845 performs packet classification into QoS Flows according to QoS rules received from SMF 310, according to the difference solutions and embodiments described above. It should be appreciated that the application software module 841, 845 is software implemented by a processor of the electronic device. In some embodiments the application software module 845 is an application software module which acts as an interface between non-QoS aware application software 840 and the 3GPP Network interface module 811.

An aspect of the disclosure provides a method of transmitting protocol data unit (PDU) packets of a PDU session, the method performed by a core network user plane function in communication with a data network over an N6 interface. The method includes obtaining a quality of service (QoS) flow identifier (QFI) of a received uplink PDU packet of the PDU session. The method further includes identifying N6 header information associated with the QFI, and transmitting the uplink PDU packet with the identified N6 header information. In some embodiments, the PDU session is an unstructured PDU session including multiple QoS flows. In some embodiments, identifying N6 header information comprises checking a mapping between the QFI and the N6 header information. In such embodiments, transmitting the uplink PDU packet with the identified N6 header information includes transmitting an encapsulated uplink PDU packet including the uplink PDU packet with the identified N6 header information. In some embodiments, the received UpLink PDU packet is one of an N3 and N9 packet. In such embodiments, the method further includes removing one of the N3 header and the N9 header, and encapsulating the uplink PDU packet with the N6 header information to form the encapsulated uplink PDU packet. In some embodiments, the identified N6 header information is QoS flow information and carried in an Extension Header of the uplink PDU packet. In some embodiments, the identified N6 header information is an assigned IP address and carried as the IP source in the IP packet header of the uplink PDU packet, the assigned IP address corresponding to a previously received mapping, from a session management function, between the assigned IP address and a QoS flow. In some embodiments, the method further includes identifying a UDP port associated with a QoS flow, wherein the transmitting the uplink PDU packet with the identified N6 header information step includes transmitting the uplink packet with the UDP port included in the uplink packet. In some embodiments, there are multiple QoS flows for the tunnel between the Core Network and the Data Network. In some embodiments, the PDU session is an unstructured PDU session. In some embodiments, the N6 header information includes at least one of: an IP address; an IP prefix; a Flow Label; a Traffic Class; a port of the UPF; and an IP Extension Header. In some embodiments, the method further includes receiving a downlink packet having the N6 header information associated with the QFI of at least one of an N3 and N9 interface, and transmitting the downlink packet in accordance with an QoS flow of the PDU session. In some such embodiments, transmitting the downlink packet in accordance with the QoS flow of the unstructured PDU session includes transmitting the downlink packet with one of N3 and N9 header information including the QFI associated with the N6 header information towards the Radio Access Network. In some such embodiments, before transmitting the downlink packet, the method further includes obtaining the N6 header information; identifying one of N3 and N9 header information including the QFI associated with the N6 header information; removing the N6 header information; and inserting the corresponding one of N3 and N9 header information into the packet. In some embodiments, the method further includes identifying a UDP port associated with a QoS flow. In some such embodiments, the method further includes transmitting the downlink packet in accordance with the QoS flow of the unstructured PDU session comprises transmitting the downlink packet in accordance with the QoS flow associated with the UDP port included in the downlink packet.

Another aspect of the disclosure includes a method of transmitting protocol data unit (PDU) packets of a PDU session, the method performed by a user plane function. The method includes obtaining IP header information of a received downlink PDU packet of the PDU session, the packet having N6 header information associated with the quality of service (QoS) flow identifier (QFI) of at least one of an N3 and N9 interface. The method further includes identifying a packet detection rule associated with the QFI, and transmitting the downlink PDU packet using the identified packet detection rule. In some embodiments, the QoS enforcement rule is a QoS handling rule. In some embodiments, the received downlink PDU packet is received over an N6 interface, and transmitting the downlink PDU includes transmitting the downlink PDU with one of an N3 packet header and an N9 packet header which is associated with a downlink mapping between N6 header information and the QFI of one of an N3 packet header and an N9 packet header. In some embodiments, the packet detection rule identifies a QFI to IP address mapping.

Another aspect of the disclosure provides an electronic device including a processor, at least one radio unit for communicating with a mobile network, and machine readable memory, storing machine executable instructions which when executed by the processor, cause the electronic device to receive at least one QoS rule including at least one Quality of Service (QoS) flow identifier (QFI) for an unstructured Protocol Data Unit (PDU) session from the mobile network; and classify packets into QoS flows according to the QoS rule by an application software module executing on the electronic device, the application software module separate from the at least one radio unit. In some embodiments, the machine readable instructions cause the electronic device to classify packets into multiple QoS flows for a single unstructured PDU. In some embodiments, the machine readable instructions cause the electronic device to implement the application software module configured to classify packets into QoS flows according the QoS rules including QFIs. In some embodiments, the application software module is an application software module which acts as an interface between non-QoS aware application software and the at least one radio unit for communicating with a mobile network.

Another aspect of the disclosure provides a method of establishing a PDU session performed by an SMF. Such a method includes receiving a request for the PDU session; establishing multiple QoS flows for the PDU session; and sending instructions to a user plane function including a packet detection rule for multiple QoS flows for the PDU session, the packet detection rule including a mapping between a Quality of Service (QoS) flow identifier (QFI) and an IP address. In some embodiments, the PDU session is an unstructured PDU session. In some embodiments, the method further includes establishing multiple N6 tunnels for each unstructured PDU session, with each of the multiple QoS flows mapped to one of the multiple N6 tunnels. In some embodiments, the method further includes establishing one N6 tunnel for each of the multiple QoS flows.

Another aspect of the disclosure provides an SMF including a processor, a non-transitory computer readable storage medium including software instructions configured to control the processor to implement the steps described. For example these steps include receiving a request for the PDU session; establishing multiple QoS flows for the PDU session; and sending instructions to a user plane function including a packet detection rule for multiple QoS flows for the PDU session, the packet detection rule including a mapping between a Quality of Service (QoS) flow identifier (QFI) and an IP address.

Another aspect of the disclosure provides a user plane function including a processor, a non-transitory computer readable storage medium including software instructions configured to control the processor to implement the steps described. For example such steps include obtaining a quality of service (QoS) flow identifier (QFI) of a received uplink PDU packet of the PDU session, identifying N6 header information associated with the QFI, and transmitting the uplink PDU packet with the identified N6 header information.

Another aspect of the disclosure provides a user plane function including a processor, a non-transitory computer readable storage medium including software instructions configured to control the processor to implement the steps described. For example such steps include obtaining IP header information of a received downlink PDU packet of the PDU session, the packet having N6 header information associated with the quality of service (QoS) flow identifier (QFI) of at least one of an N3 and N9 interface. The steps further includes identifying a packet detection rule associated with the QFI, and transmitting the downlink PDU packet using the identified packet detection rule.

Network management entities carrying out or controlling the methods described above may be resident within a management plane of a communications network. These entities may interact with control plane entities (and possibly user/data plane entities) within the network slices instances that are created and discussed. These network management entities may provide methods and functions for the utilization of slice templates and slice instance profiles to satisfy or address (wholly or in part) communication service requests. These communication service requests may be received from a customer of a service provider. Addressing the communication service requests may include taking into account aspects of the lifecycle management of communication service instances and network slices instances.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method of transmitting protocol data unit (PDU) packets of a PDU session, the method performed by a core network user plane function in communication with a data network over an N6 interface, the method comprising:
obtaining a quality of service (QoS) flow identifier (QFI) of a received uplink PDU packet of the PDU session;
identifying N6 header information associated with the QFI; and
transmitting the uplink PDU packet with the identified N6 header information.

2. The method as claimed in claim 1 wherein the PDU session is an unstructured PDU session including multiple QoS flows.

3. The method as claimed in claim 1 wherein:
identifying N6 header information comprises checking a mapping between the QFI and the N6 header information; and
transmitting the uplink PDU packet with the identified N6 header information comprises transmitting an encapsulated uplink PDU packet including the uplink PDU packet with the identified N6 header information.

4. The method as claimed in claim 3 wherein:
the received UpLink PDU packet is one of an N3 and N9 packet;
the method further comprising:
removing one of the N3 header and the N9 header; and
encapsulating the uplink PDU packet with the N6 header information to form the encapsulated uplink PDU packet.

5. The method as claimed in claim 3 wherein the identified N6 header information is QoS flow information and carried in an Extension Header of the uplink PDU packet.

6. The method as claimed in claim 3 wherein the identified N6 header information is an assigned IP address and carried as the IP source in the IP packet header of the uplink PDU packet, the assigned IP address corresponding to a previously received mapping, from a session management function, between the assigned IP address and a QoS flow.

7. The method as claimed in claim 1 further comprising:
identifying a UDP port associated with a QoS flow;
wherein the transmitting the uplink PDU packet with the identified N6 header information comprises transmitting the uplink packet with the UDP port included in the uplink packet.

8. The method as claimed in claim 1 there are multiple QoS flows for the tunnel between the Core Network and the Data Network.

9. The method as claimed in claim 1, wherein the N6 header information comprises at least one of:
an IP address;
an IP prefix;
a Flow Label;
a Traffic Class;
a port of the UPF; and
an IP Extension Header.

10. The method of claim 4 further comprising:
receiving a downlink packet having the N6 header information associated with the QFI of at least one of an N3 and N9 interface; and
transmitting the downlink packet in accordance with an QoS flow of the PDU session.

11. The method as claimed in claim 10 wherein transmitting the downlink packet in accordance with the QoS flow of the unstructured PDU session comprises:
transmitting the downlink packet with one of N3 and N9 header information including the QFI associated with the N6 header information towards the Radio Access Network.

12. The method as claimed in claim 11, before transmitting the downlink packet, the method further comprising:
obtaining the N6 header information;
identifying one of N3 and N9 header information including the QFI associated with the N6 header information;
removing the N6 header information; and
inserting the corresponding one of N3 and N9 header information into the packet.

13. The method as claimed in claim 10 further comprising:
identifying a UDP port associated with a QoS flow.

14. A method of transmitting protocol data unit (PDU) packets of a PDU session, the method performed by a user plane function, the method comprising:
obtaining IP header information of a received downlink PDU packet of the PDU session, the packet having N6 header information associated with the quality of service (QoS) flow identifier (QFI) of at least one of an N3 and N9 interface;
identifying a packet detection rule associated with the QFI; and
transmitting the downlink PDU packet using the identified packet detection rule.

15. The method as claimed in claim 14 wherein the QoS enforcement rule is a QoS handling rule.

16. The method as claimed in claim 14 wherein the received downlink PDU packet is received over an N6 interface, and transmitting the downlink PDU comprises:
transmitting the downlink PDU with one of an N3 packet header and an N9 packet header which is associated with a downlink mapping between N6 header information and the QFI of one of an N3 packet header and an N9 packet header.

17. The method as claimed in claim 16 wherein the packet detection rule identifies a QFI to IP address mapping.

18. A method of establishing an unstructured PDU session performed by an SMF, the method comprising:
receiving a request for the unstructured PDU session;
establishing multiple QoS flows for the unstructured PDU session;
sending instructions to a user plane function including a packet detection rule for multiple QoS flows for the unstructured PDU session, the packet detection rule including a mapping between a Quality of Service (QoS) flow identifier (QFI) and an IP address.

19. The method as claimed in claim 18 further comprising establishing multiple N6 tunnels for each unstructured PDU session, with each of the multiple QoS flows mapped to one of the multiple N6 tunnels.

20. The method as claimed in claim 18 further comprising establishing one N6 tunnel for each of the multiple QoS flows.
